(19) United States
(12) Patent Application Publication
(10) Pub. No.: US 2010/0008351 A1
(43) Pub. Date: Jan. 14, 2010

(54) METHOD AND SYSTEM FOR ROUTE SYNCHRONIZATION USING TIME SYNCHRONIZATION

(75) Inventors: Peter ASHWOOD-SMITH, Gatineau (CA); Kent FELSKE, Kanata (CA); Michel OUELLETTE, Orleans (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: NORTEL NETWORKS LIMITED, Saint-Laurent (CA)

(21) Appl. No.: 12/169,189

(22) Filed: Jul. 8, 2008

(51) Int. Cl. H04J 3/06

(52) U.S. Cl. 370/350

(57) ABSTRACT

A system, method and apparatus synchronize protocol events in a distributed communication network. The network includes a plurality of nodes. Each node in the network includes a time source which maintains a clock signal synchronized with each other node time source in the network. An announcement of a protocol event is sent to at least one node. The announcement includes a predetermined time for implementing the protocol event. The protocol event is acted upon at the predetermined time.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to a method and system for routing data in a communication network, and more specifically, to a method and system for applying topology changes in a synchronized manner throughout a distributed network by time-stamping events/updates with a precise time of execution.

### BACKGROUND OF THE INVENTION

In a distributed communication network, the time at which each individual component, such as nodes, access points, and routers, acts upon a common event is not synchronous. One of the biggest problems with data routing in a distributed network is that not all nodes have the same view of the network at the same time. There is an inherent delay involved in distributing notification of an event throughout the entire network. Examples of events which may cause time delays include network failure, deliberate changes in the network structure, and basic laws of physics.

At any given time, each node in a network is aware of the status of all other active nodes. Whenever data is available for distribution, each node determines a route for forwarding data through the network based on that node's perception of the present condition of the network. A number of factors determine the route chosen by the node, including which nodes and links are active, link utilization, the traffic flow/distribution requirements, etc. Ideally, if all the nodes have the same view of the network, at any given instant, each node would choose to route the data according to the same paths through the network.

In reality, delays within the system often cause the nodes to have different views of the network, resulting in the nodes choosing different i.e., non-optimal, paths for routing a particular set of data. Any time differences result in poor quality or incorrect routes, with the worst case being looped traffic. A routing loop forms when an error or unintended miscalculation occurs in the operation of the routing procedure, resulting in the path to a particular destination forming a loop among a particular group of nodes. In a classic example, for a network having three nodes (A, B, and C), node A transmits data to node C through node B. If the link between nodes B and C is broken, but node A has not yet learned of the breakage, node A transmits the data to node B assuming that the link A-B-C is the optimal route. Node B knows of the broken link and tries to reach node C via node A, thus sending the original data back to node A. Furthermore, node A receives the data that it originated back from node B and consults its routing table. Node A's routing table will say that it can reach node C via node B (because it still has not been informed of the break) thus sending its data back to node B creating an infinite loop. Routing loops unnecessarily tie up network resources and available bandwidth that would otherwise be free to route traffic.

For multicast traffic, route looping can be catastrophic. Using IP multicast, a source only has to send a packet once, even if the packet is to be delivered to a large number of receivers. The nodes in the network replicate the packet as necessary to reach multiple receivers. In the worst case, when looping occurs in this situation, thousands or even millions of copies of the same data packets can be continuously bounced around between nodes until the entire system is completely saturated and is unusable for actually routing other data traffic.

To combat the above-mentioned problems, a network will sometimes be configured to deliberately react slowly, or will require that the flow of certain traffic be disabled while the network “converges.” At the control level, the only remedies or preventative measures currently in place include trying to process messages as fast as possible, attempting to reduce packetization delay for control packets, etc. One “band-aid fix” for the looping problem is to insert a “time to live” (“TTL”) factor in data packets, which limits the amount of time or number of iterations or that a data packet can experience before it is discarded. However, the TTL value does not prevent looping or incorrect routing; it only minimizes the damage experienced by the network when these events occur. Additionally, some protocols may disable multicast traffic for some given time period, waiting for the network to converge. In effect, this remedy discourages multicast traffic because it either prevents the broadcasting of multicast traffic at unpredicted times or creates a backlog of messages to be delivered when the restriction is lifted.

Therefore, what is needed is a method and system for applying topology changes in a synchronized manner throughout a distributed network such that each node in the network has the same view of the network when making routing decisions.

### SUMMARY OF THE INVENTION

The present invention advantageously provides a method, system and apparatus for synchronizing protocol events in a distributed communication network. Generally, the present invention advantageously provides a time source for each node which is synchronized to each other node time source in the network. Protocol events are pre-announced and acted upon simultaneously by each affected node.

One aspect of the present invention provides a method for synchronizing protocol events in a distributed communication network. The network includes a plurality of nodes. A time source is maintained for each node in the network. Each time source includes a clock signal synchronized with each other node time source in the network. An announcement of a protocol event is sent to at least one node. The announcement includes a predetermined time for implementing the protocol event. Each affected node acts upon the protocol event at or after the predetermined time.

In accordance with another aspect, the present invention provides a distributed communication network that includes a plurality of nodes. Each node has a time source that maintains a clock signal synchronized with each other node time source in the network. Each node is operable to receive an announcement of a protocol event. The announcement includes a predetermined time for implementing the protocol event. Each node acts upon the protocol event at or after the predetermined time.

In accordance with yet another aspect, the present invention provides an apparatus for routing data packets in a distributed communication network. The apparatus includes a time source, a communication interface and a processor. The processor communicatively coupled to the time source and the communication interface. The time source maintains a clock signal synchronized with each other time source in the network. The communication interface is operable to receive an announcement of a protocol event. The announcement includes a predetermined time for implementing the protocol event. The processor is operable to act upon the protocol event at or after the predetermined time.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a distributed communication network constructed in accordance with the principles of the present invention;

FIG. 2 is a block diagram of a configuration manager constructed in accordance with the principles of the present invention; and

FIG. 3 is a flowchart of an exemplary synchronized event announcement process according to the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for applying topology changes in a synchronized manner throughout a distributed network by time-stamping events/updates with a precise time of execution. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. Additionally, as used herein and in the appended claims, the term “Zigbee” relates to a suite of high-level wireless communication protocols as defined by the Institute of Electrical and Electronics Engineers (“IEEE”) standard 802.15.4. Further, “Wi-Fi” refers to the communications standard defined by IEEE 802.11. The term “WiMAX” means the communication protocols defined under IEEE 802.16. “BLUETOOTH” refers to the industrial specification for wireless personal area network (“PAN”) communication developed by the Bluetooth Special Interest Group.

One embodiment of the present invention advantageously provides a method and system for routing data packets in a distributed network by synchronizing the time for applying topology changes throughout a distributed network such that each node in the network has the same view of the network when making routing decisions. An embodiment of the present invention utilizes precision timing, such as provided by an atomic clock, to guarantee that each element in the network is operating according to the same timeframe, within a few microseconds. Thus, topology changes may be scheduled, pre-announced, and implemented without disruption to the network as each element knows exactly when the network configuration will change.

In one embodiment of the present invention, when a protocol event occurs, rather than being processed locally and then forwarded, the event is marked with an absolute precise “wall clock” time to be processed in the future, and then forwarded to other devices in the network. Devices within the network act on the event at that exact designated “wall clock time”. Protocol events may include route changes, additions, or deletions; resource availability changes, additions, or deletions; link metric changes; link availability changes, additions, or deletions; and service membership changes, additions, or deletions.

The present invention may be implemented in networks that use internal or external routing protocols, such as Open Shortest Path First (“OSPF”), Border Gateway Protocol (“BGP”), Interior Gateway Protocol (“IGP”), Intermediate system to intermediate system (“IS-IS”), etc. The present invention tremendously reduces the probability of packet looping or packets following incorrect path topologies as the implementation of pre-announced topology changes occur at nearly the exact same time network wide.

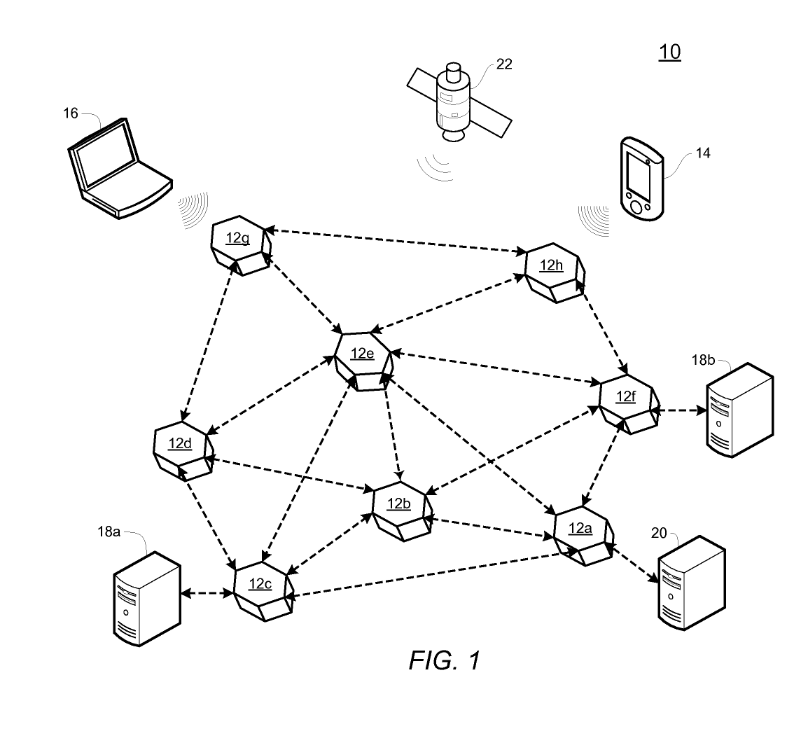

Referring now to the drawing figures in which like reference designators refer to like elements, there is shown in FIG. 1 a distributed communication network 10 for synchronizing topology changes through the use of precision timing. Network 10 includes an array of nodes 12a, 12b, 12c, 12d, 12e, 12f, 12g and 12h (referred to collectively as nodes 12). The nodes 12 may include wireless access points, hubs, routers, switches, gateways, or any other device commonly known to forward data packets in a communication network. Network 10 also may include a plurality of client devices, such as a portable data assistant (“PDA”) 14, a laptop computer 16, a desktop computer 18a, 18b (two shown), and a configuration manager 20. Each node 12 may be hard-wired to neighboring nodes 12 and/or client devices and routes data packets between client devices using any combination of commonly used wired and/or wireless communication protocols such as Transmission Control Protocol/Internet Protocol (“TCP/IP”), Ethernet, etc. Additionally, each node 12 may communicate with neighboring nodes 12 and/or client devices using radio frequency (“RF”) signals encoded according to standard communication protocols, such Wi-Fi, Wi-MAX, Zigbee, BLUETOOTH, etc. Additionally, each node 12 and client device may include an atomic clock (not shown), or other means for obtaining and/or maintaining a precision reference clock, such as receiving updates of the precise time from a satellite 22 having an on-board atomic clock.

Communication network 10 may be a wide-area network such as the Internet, intranet, or other communication network, including but not limited to a personal area networks (“PAN”), local area networks (“LAN”), campus area networks (“CAN”), metropolitan area networks (“MAN”), etc. Each client computer 16 may also be used as a configuration manager 20, which is used to announce time-stamped updates to the routing topology for the network 10 and is discussed in detail below. It should be noted that network 10 may include any number of client computers devices and nodes 12. The amount and type of client devices and nodes 12 shown in FIG. 1 is for illustrative purposes only and does not limit the scope of the present invention.

The configuration manager 20 may be implemented as a portion of any node 12, (e.g., router, switch, gateway, hub, etc.), client device, or other interface device, or may be implemented as a stand-alone device or as part of a computer monitoring system. Additionally, each client computer 16 may include its own configuration manager 20 for announcing updates to the routing topology. In other words, the configuration manager 20 of the present invention can be implemented as a logical process in any network element that has data to process. As such, the arrangement in FIG. 1 is merely exemplary and is included solely to aid understanding of the invention.

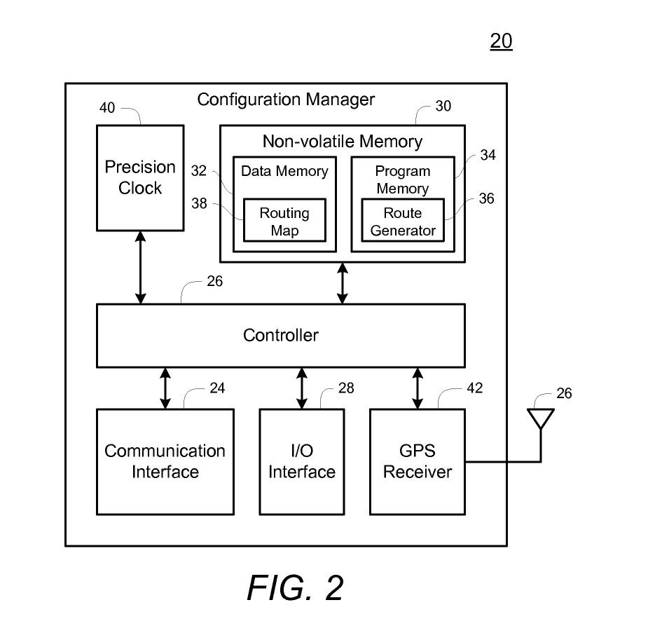

Referring now to FIG. 2, an exemplary configuration manager 20 includes a communication interface 24 communicatively coupled to a controller 26. The communication interface 24 may be wired, wireless, or any combination thereof. The communication interface 24 transfers data packets between the configuration manager 20 and the network nodes 12 using known communication protocols, e.g., Ethernet, Wi-Fi, etc. The controller 26 controls the processing of information and the operation of the configuration manager 20 in a well-known manner. The controller 26 is also coupled to an input/output interface 28 and a non-volatile memory 30. The input/output interface 28 controls the reception and presentation of information to and from a user through various well-known peripheral devices such as a display screen, a keyboard, a mouse, a printer, etc.

The non-volatile memory 30 includes a data memory 32 and a program memory 34. The program memory 34 contains a route generator 36 which determines the optimal routing topology of the communication network 10, the operation of which is discussed in more detail below. The data memory 32 stores data files such a route map 38 which is created by the route generator 36 and contains a path for routing data through the network 10 and various other user data files (not shown). The configuration manager 20 may also include a precision clock 40, such as an atomic clock, used to maintain a reference time signal that is extremely accurate. Alternatively, the configuration manager 20 may include a means for periodically receiving updates to adjust a clock in order to maintain a reference timeframe accurate to within a few microseconds, e.g., receiving updates through a Global Positioning System (“GPS”) receiver 42 from a satellite 22 having an atomic clock that maintains a continuous and stable time scale such as the International Atomic Time (“TAI”). Aside from getting a reference from a satellite, the reference can be distributed through the links that make up the network from a master clock source. This is referred to as Layer 1 or Layer 2 clock distribution.

The time synchronization precision required to implement the present invention can vary. The greater the precision the less packet loss/looping that will occur. Likewise, the worse the precision the more loss/looping there will be. For example, if the normal delay difference without any synchronization or events to be processed is T seconds, if clocks are introduced that are accurately synchronized to T/2 seconds, then the loss/looping is reduced by ½. Ideally the precision should be at least an order of magnitude better than T. Since T is typically on the order of a second, 1/100^{th} of a second would be a good starting point and 1/1000 or so even better.

Because all of the nodes 12 within the network 10 also include a precision clock or other means for receiving updates to adjust their internal clocks, all time references within the network 10 are accurate to within a few microseconds of each other.

One embodiment of the present invention advantageously refrains from acting on a protocol event, such as a topology configuration change, immediately upon reception/detection. Instead, the event is held and announcement of the event, including a designated time to act, is forwarded on to all other nodes 12 in the network 10 that are to act. Every impacted node 12 in the network 10 acts upon the event at the designated time, preventing incorrect routing decisions caused when individual nodes 12 act upon different information. For example, each impacted node 12 may update its routing table to account for a failed link or to add a new node at the same time.

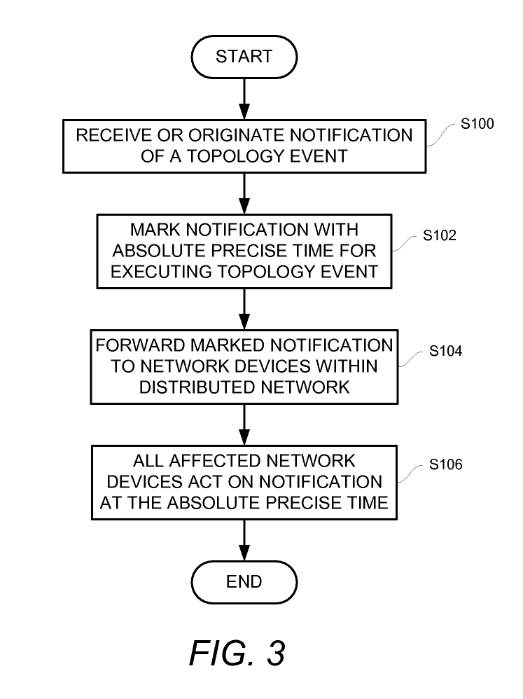

Referring now to FIG. 3, an exemplary operational flowchart is provided that describes steps performed by the route generator 36 for announcing events to the network 10. The process begins when the route generator 36 receives or originates a notification of a network topology event (step S100). Network topology events may include adding a new resource such as a new node or fiber, removing a resource, temporarily detouring communication away from a particular node, phased time of day routing changes, etc. The route generator 36 marks the notification with an absolute precise time at or after which the topology event may be carried out (step S102). The precise time may either be a predetermined time that is included in the original notification or may be a delay factor that is calculated based on the present configuration of the network. For example, the delay may be calculated as:

Delay=((PD+NP)*H)+C,

where PD is the propagation delay between nodes, NP is the nodal processing time for an event, H is the number of hops until the destination device, and C is a constant representing extra time for padding. Alternatively, the absolute precise time may be determined based on the type of event received. For example, a notification concerning the addition of a new node may be acted upon at t₁, but the removal of a node is to be acted upon at t₂.

The marked notification is forwarded to network devices within the distributed network 10 (step S104) that are to change based on the event. The marked notification may be in the form of, for example, a link state message. All the affected network devices act upon the event at the absolute precise time indicated in the notification (step S106). In this manner, all the network devices are synchronized to act upon an event to previously unattainable tolerances, e.g., under 1 ms duration. Previously, implementation of a particular event could require seconds to complete, resulting in loss or looping of a similar duration. The present invention greatly reduces the probability of incurring any losses or looping due to asynchronously implementing network changes, resulting in resources having differing views of the network at a given time. Further, the present invention limits the duration of any losses or looping actually incurred to less than a millisecond, i.e., typically a few micro seconds.

Typical implementations of protocol events where the principles of the present invention provide noticeable improvements include scheduling the addition of a new node at a specific time. An embodiment of the present invention allows a notification to be sent out to all the nodes 12 in the network enabling the nodes to “see” the new node, but preventing use of the new node as a routable option until the designated time.

Another protocol event may occur when a link fails, but local bypass mechanisms are in place to deal with the failure. These local mechanisms can be envisioned as comparable to the situation of travelling in a car and encountering a section of a road that is closed, but a detour is in place which diverts traffic around the closed portion. Generally, the detour is not the most efficient or economical route to travel, and many times, if a traveler had prior knowledge that the detour was in place, a different route would have been chosen. Likewise, these same general principles apply to local bypass mechanisms. These local bypass mechanisms divert traffic originally intended to travel through a failed link on a different path. Often, the diverted route is expensive to maintain and is not an optimal solution. By using the principles of the present invention, once a link fails and the bypass mechanism temporarily takes over, the network can recover by sending a notification that the failed link will not be available for routing beginning at a precise time, thereby minimizing the use of the local bypass mechanism for a very short-term basis.

Another protocol event may include accounting for changes in route maps due to network resources being assigned different priority values depending upon traffic levels or the time of day. For example, in most networks traffic patterns vary greatly over the course of the day. At certain times, traffic may be particularly heavy and the network may struggle to meet guaranteed data rates, while at other times, there is very little data traffic and not all the network resources are required in order for the network to function properly. For networks that implement priority-based routing, each resource in the network may be assigned a different priority value based upon the traffic patterns of the network. The result is that the route map for each node may change depending upon the priority values assigned for a traffic model at a certain time. By implementing the precision timing and announcement mechanism of the present invention, the network is able to switch between traffic models with minimal negative impact.

Additionally, embodiments of the present invention allow for routine maintenance and network upgrades to be scheduled before-hand and the actual implementation of these events to have a minimal impact on the network as all devices within the network act on these events in a time span of less than a millisecond. Thus, any negative effects resulting from events such as the removal or deactivation of a node or other resource are kept to a minimum.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for synchronizing protocol events in a distributed communication network, the network including a plurality of nodes, the method comprising:
maintaining a time source for each node in the network, each time source including a clock signal synchronized with each other node time source in the network;
sending an announcement of a protocol event to at least one node, the announcement including a predetermined time for implementing the protocol event; and
acting upon the protocol event after expiration of the predetermined time.

2. The method of claim 1, wherein the time source is one of an atomic clock and a precision clock.

3. The method of claim 1, wherein maintaining a time source for each node in the network comprises:
periodically receiving a reference time signal from a remote time source; and
updating the clock signal to correlate with the reference time signal.

4. The method of claim 3, wherein the reference time signal is received through one of Layer 1 and Layer 2 clock distribution.

5. The method of claim 1, wherein the protocol event is one of a route change, a route addition, and a route deletion.

6. The method of claim 1, wherein the protocol event is one of a resource availability change, a resource addition, and a resource deletion.

7. The method of claim 1, wherein the protocol event is one of a link metric, a link availability change, a link addition, and a link deletion.

8. The method of claim 1, wherein the protocol event is one of a service membership change, a service membership addition, and a service membership deletion.

9. The method of claim 1, wherein the network operates using at least one of a Border Gateway Protocol (“BGP”), an Open Shortest Path First (“OSPF”) protocol, and an Intermediate System to Intermediate System (“IS-IS”) protocol.

10. The method of claim 9, wherein the predetermined time is included in one of a BGP protocol message, an OSPF protocol message and an IS-IS protocol message.

11. A distributed communication network comprising:
a plurality of nodes, each node including a time source maintaining a clock signal synchronized with each other node time source in the network, each node operable to:
receive an announcement of a protocol event, the announcement including a predetermined time for implementing the protocol event; and
act upon the protocol event after expiration of the predetermined time.

12. The distributed communication network of claim 11, further comprising:
a configuration manager communicatively coupled to each node of the plurality of nodes, the configuration manager operable to:
append the predetermined time to a topology configuration message, thereby creating the announcement of the topology configuration event; and
send the announcement of the topology configuration event to at least some of the nodes.

13. The distributed communication network of claim 11, wherein the time source is one of an atomic clock and a precision clock.

14. The distributed communication network of claim 11, wherein the time source for each resource in the network is maintained by:
periodically receiving a reference time signal from a remote source; and
updating the clock signal to correlate with the reference time signal.

15. The distributed communication network of claim 11, wherein the protocol event is a temporary alternative route, the alternative route effective for a given duration.

16. The distributed communication network of claim 11, wherein the network operates using one of a Border Gateway Protocol (“BGP”), an Open Shortest Path First (“OSPF”) protocol, and an Intermediate System to Intermediate System (“IS-IS”) protocol.

17. The distributed communication network of claim 16, wherein the predetermined time is included one of a BGP protocol message, an OSPF protocol message and an IS-IS protocol message.

18. An apparatus for routing data packets in a distributed communication network, the apparatus comprising:
a time source, the time source maintaining a clock signal synchronized with each other time source in the network;
a communication interface, the communication interface operable to receive an announcement of a protocol event, the announcement including a predetermined time for implementing the protocol event; and
a processor, the processor communicatively coupled to the time source and the communication interface, the processor operable to act upon the protocol event at the predetermined time.

19. The apparatus of claim 18, wherein the time source is one of an atomic clock and a precision clock.

20. The apparatus of claim 18, further comprising:
a Global Positioning System (“GPS”) receiver, the GPS receiver operable to periodically receive a reference time signal from a remote source; and
wherein the processor is further operable to update the clock signal to correlate with the reference time signal.
